(19) United States
(12) Patent Application Publication
(10) Pub. No.: US 2013/0163045 A1
(43) Pub. Date: Jun. 27, 2013

(54) PRINTING SERVER, PRINTING SYSTEM, AND PRINTING METHOD

(71) Applicants: KABUSHIKI KAISHA TOSHIBA, Tokyo (JP); TOSHIBA TEC KABUSHIKI KAISHA, Tokyo (JP)

(72) Inventor: Kazuhiko Sato, Shizuoka-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/716,754

(22) Filed: Dec. 17, 2012

Related U.S. Application Data
(60) Provisional application No. 61/580,394, filed on Dec. 27, 2011.

(51) Int. Cl. G06F 3/12

(52) U.S. Cl. CPC G06F 3/1296
USPC 358/1.15

(57) ABSTRACT

According to one embodiment, a printing server includes a communication unit, a storing unit, an information-file generating unit, and a control unit. The communication unit communicates with an information processing apparatus that outputs a printing job, another printing server, and a printing apparatus. The storing unit receives the printing job transmitted from the information processing apparatus and stores the printing job. The information-file generating unit generates, on the basis of the printing job, an information file for managing the printing job stored in the storing unit. The control unit transmits the information file generated by the information-file generating unit to the other printing server via the communication unit and, if receiving, via the other printing server, a printing job request from the printing apparatus that communicates with the other printing server, transmits the printing job stored in the storing unit to the printing apparatus.

### CROSS-REFERENCE TO RELATED APPLICATIONS

This application is based upon and claims the benefit of priority from U.S. Provisional Application No. 61/580,394 filed on Dec. 27, 2011; the entire contents of which are incorporated herein by reference.

### FIELD

Embodiments described herein relate generally to a printing server, a printing system, and a printing method.

### BACKGROUND

A printer driver of a PC or the like transmits a printing job including printing data to a printing server. The printing server registers the printing job transmitted from the printer driver. A printing apparatus displays a printing job list registered in the printing server. When a user selects a printing job from the printing job list, the printing apparatus requests the printing server to transmit the selected printing job, receives the printing job from the printing server, and executes printing based on the printing job.

There is a demand for a printing system in which printing servers are arranged in a plurality of bases, printing apparatuses are connected to the respective printing servers, and printing can be executed from any one of the printing apparatuses.

### DESCRIPTION OF THE DRAWINGS

FIG. 1 is a diagram of an example of a schematic configuration of a printing system according to an embodiment;

FIG. 2 is a diagram of an example of a printing job list screen according to the embodiment;

FIG. 3 is a flowchart for explaining an example of printing processing by the printing system;

FIG. 4 is a diagram of an example of an information file according to the embodiment;

FIG. 5 is a diagram of an example of a transmission instruction according to the embodiment;

FIG. 6A is a diagram of an example of functional blocks of apparatuses included in the printing system; and

FIG. 6B is a diagram of an example of functional blocks of apparatuses included in the printing system.

### DETAILED DESCRIPTION

In general, according to one embodiment, a printing server includes a communication unit, a storing unit, an information-file generating unit, and a control unit. The communication unit communicates with an information processing apparatus that outputs a printing job, another printing server, and a printing apparatus. The storing unit receives the printing job transmitted from the information processing apparatus and stores the printing job. The information-file generating unit generates, on the basis of the printing job, an information file for managing the printing job stored in the storing unit. The control unit transmits the information file generated by the information-file generating unit to the other printing server via the communication unit and, if receiving, via the other printing server, a printing job request from the printing apparatus that communicates with the other printing server, transmits the printing job stored in the storing unit to the printing apparatus.

An embodiment is explained below with reference to the drawings.

FIG. 1 is a diagram of an example of a schematic configuration of a printing system according to the embodiment.

In the printing system, an intranet A and an intranet B are connected. A printing apparatus (a multi-functional peripheral (MFP)) A1, a printing server A2, and a plurality of computers (printing job output apparatuses) A3 are connected to the intranet A. A printing apparatus B1, a printing server B2, and a plurality of computers B3 are connected to the intranet B.

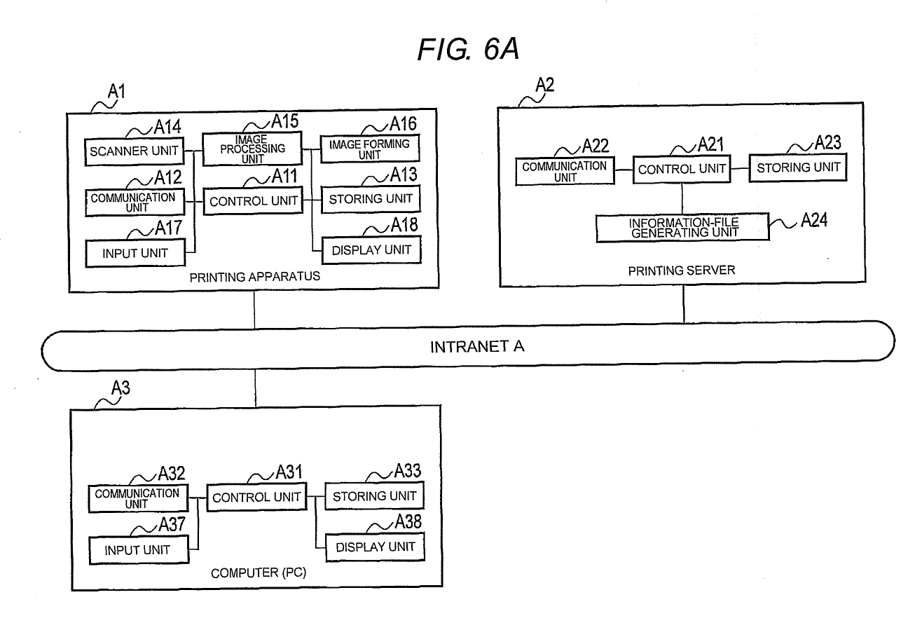

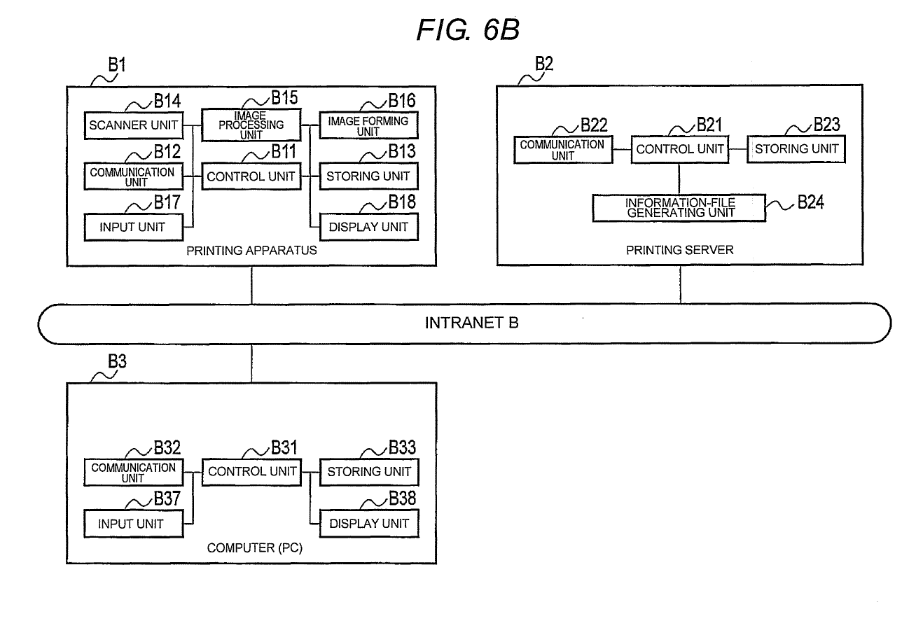

FIGS. 6A and 6B are diagrams of examples of functional blocks of the apparatuses included in the printing system according to the embodiment.

The printing apparatus A1 includes a control unit A11, a communication unit A12, a storing unit A13, a scanner unit A14, an image processing unit A15, an image forming unit A16, an input unit A17, and a display unit A18. The printing server A2 includes a control unit A21, a communication unit A22, a storing unit A23, and an information-file generating unit A24. The computer (PC) A3 includes a control unit A31, a communication unit A32, a storing unit A33, an input unit A37, and a display unit A38.

Similarly, the printing apparatus B1 includes a control unit B11, a communication unit B12, a storing unit B13, a scanner unit B14, an image processing unit B15, an image forming unit B16, an input unit B17, and a display unit B18. The printing server B2 includes a control unit B21, a communication unit B22, a storing unit B23, and an information-file generating unit B24. The computer (PC) B3 includes a control unit B31, a communication unit B32, a storing unit B33, an input unit B37, and a display unit B38.

In the following explanation in this embodiment, the printing system includes the printing server A2 and the printing server B2. However, the printing system may include three or more printing servers. This enables the printing system to be adapted to three or more intranets.

The printing system identifies (specifies) a user using a user ID or the like and prints a printing job corresponding to the identified user. Irrespective of in which of the printing servers the user (a printing-job output apparatus) registers the printing job, the user can print the registered printing job from any printing apparatus.

Printing by the printing system is explained below with reference to FIG. 3.

The user instructs, via the computer A3 (an information processing apparatus), the printing system to output a printing job. The communication unit A32 of the computer A3 transmits (outputs) a printing job A01 to the printing server A2 via the intranet A. The communication unit A22 of the printing server A2 receives the printing job A01 transmitted from the computer A3 (ACT 101). The control unit A21 of the printing server A2 registers (stores) the printing job A01 in the storing unit A23. The information-file generating unit A24 generates an information file A01 for managing the printing job A01 (ACT 102). The printing job A01 includes, for example, printing data, management information, and user identification information (a user ID: A).

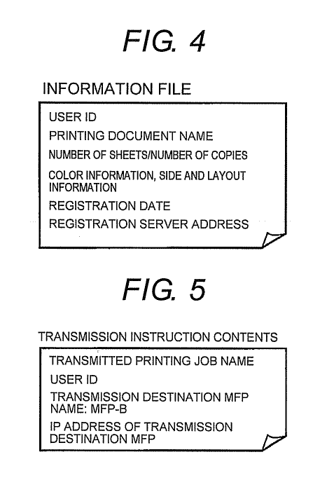

FIG. 4 is a diagram of an example of an information file according to this embodiment. The information file A01 generated from the printing job A01 does not include printing data but includes management information and user identification information. As shown in FIG. 4, the information file A01 includes a user ID, a printing document name, the number of sheets and the number of copies, color information, registration date and time information, and a registration server address (registration location information).

Further, the control unit A21 of the printing server A2 copies (transmits) the generated information file A01 to all the other printing servers via the communication unit A22. In this embodiment, the control unit A21 of the printing server A2 copies (transmits) the generated information file A01 to the printing server B2 (ACT 103).

The communication unit B12 of the printing server B2 receives the information file A01 transmitted from the printing server A2. The control unit B21 registers (stores) the information file A01 in the storing unit B23.

A user who desires to executes the printing job A01 in the printing apparatus B1 logs in to the printing apparatus B1. For example, the user inputs the user identification information (the user ID: A) and a password via the input unit B17 of the printing apparatus B1. The control unit B11 of the printing apparatus B1 refers to a user identification database and, if a combination of the user identification information and the password is registered in the user identification database, permits the login of the user (ACT 301). Alternatively, the control unit B11 of the printing apparatus B1 transmits the user identification information and the password to another server (an authentication server, etc.), receives a user identification result in the other server, and permits the login on the basis of the received result.

If the login is permitted, the communication unit B12 of the printing apparatus B1 transmits login information including the user identification information to the printing server B2. The communication unit B22 of the printing server B2 receives the login information including the user identification information. The control unit B21 of the printing server B2 retrieves a registered information file corresponding to the login information. In other words, the control unit B21 of the printing server B2 retrieves an information file including the user identification information included in the login information. In this case, the control unit B21 of the printing server B2 detects the information file A01 including the user identification information (the user ID: A) and generates printing job list display information of the user identification information (the user ID: A). The communication unit B22 of the printing server B2 transmits the printing job list display information of the user identification information (the user ID: A) to the printing apparatus B1 (ACT 201).

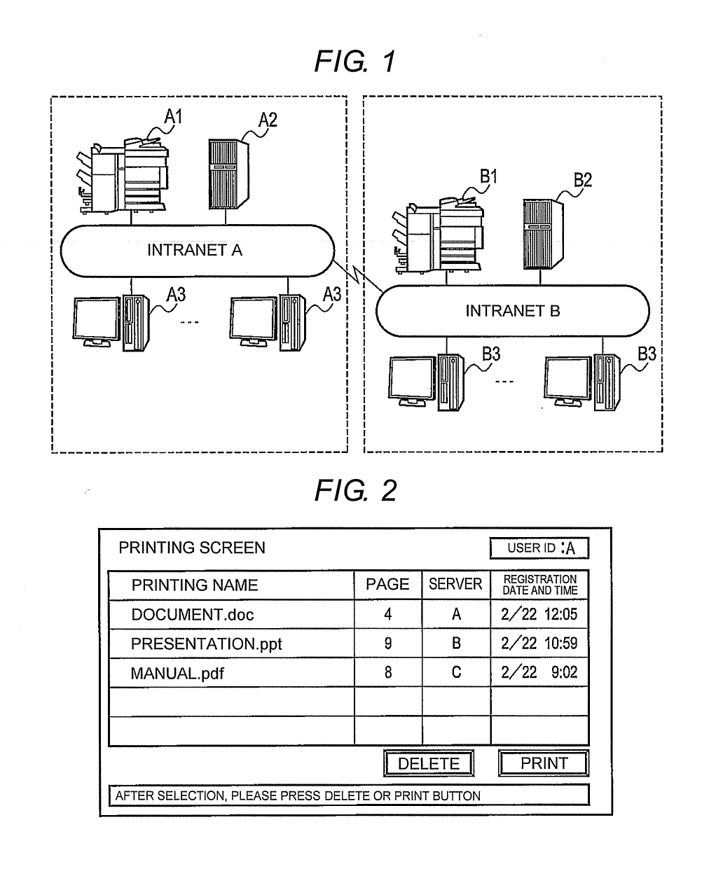

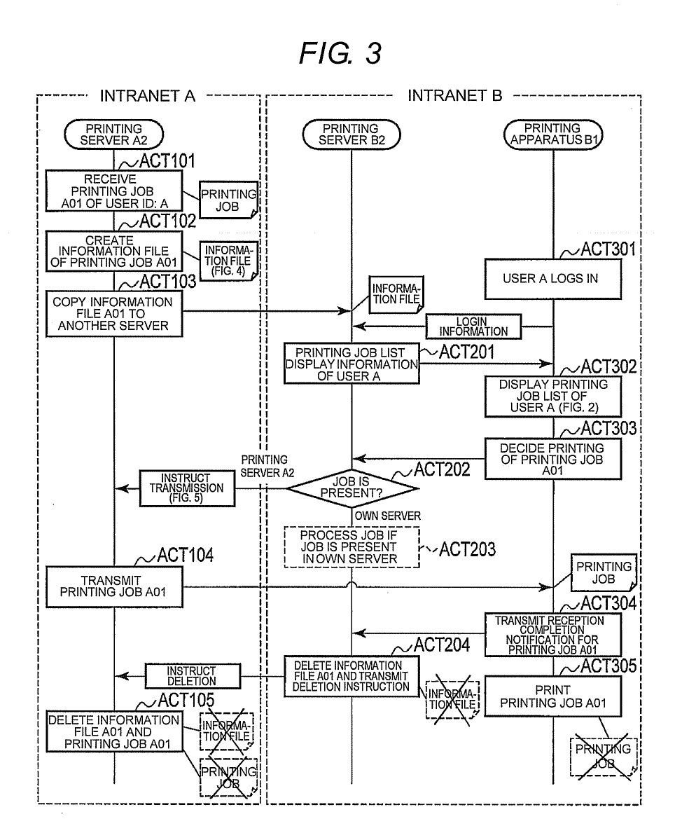

The communication unit B12 of the printing apparatus B1 receives the printing job list display information from the printing server B2. The display unit B18 of the printing apparatus El displays a printing job list based on the printing job list display information (ACT 302). For example, the display unit B18 displays a printing job list screen shown in FIG. 2. In an example of the printing job list screen shown in FIG. 2, server names, which are registration destinations of printing jobs, are displayed. However, the server names do not have to be displayed. In other words, the printing job list screen may be a printing job list screen that does not make the user aware of the registration destinations of the printing jobs.

The user can select an arbitrary printing job via the printing job list screen displayed on the display unit B18 of the printing apparatus B1. If the user selects the printing job A01, the control unit B11 of the printing apparatus B1 decides the selected printing job A01 (ACT 303). The communication unit B12 of the printing apparatus B1 requests the printing server B2 to transmit the printing job A01.

The communication unit B22 of the printing server B2 receives the request for the printing job A01. The control unit B21 of the printing server B2 searches for a registration location of the printing job A01 on the basis of the information file A01 corresponding to the printing job A01.

For example, if the printing job A01 is registered in the printing server B2 (YES in ACT 202), the communication unit B22 of the printing server B2 transmits the printing job A01 to the printing apparatus B1 (ACT 203). The communication unit B12 of the printing apparatus B1 receives the printing job A01. The image forming unit B16 executes printing based on the printing job A01.

In this case, the control unit B21 of the printing server B2 determines on the basis of the information file A01 corresponding to the printing job A01 that the registration location of the printing job A01 is the printing server A2. In other words, the control unit B21 determines that the printing job A01 is not registered in the printing server B2 but is registered (stored) in the printing server A2. Therefore, the communication unit B22 of the printing server B2 transmits, to the printing server A2, a transmission instruction for transmitting the printing job A01 to the printing apparatus B1.

FIG. 5 is a diagram of an example of the transmission instruction. As shown in FIG. 5, the transmission instruction includes a transmitted printing job name, a user ID, a transmission destination printing apparatus name (an MFP name), and an IP address of the transmission destination printing apparatus (MFP).

The communication unit A22 of the printing server A2 receives the transmission instruction from the printing server B2. The control unit A21 of the printing server A2 interprets the transmission instruction. The communication unit A22 of the printing server A2 transmits the printing job A01 registered (stored) in the storing unit A23 to the printing apparatus 81 (ACT 104).

The communication unit B12 of the printing apparatus B1 receives the printing job A01 from the printing server A2 and transmits a reception completion notification for the printing job A01 to the printing server 132 (ACT 304). The image forming unit B16 executes printing based on the printing job A01 (ACT 305).

The communication unit B22 of the printing server B2 receives the reception completion notification for the printing job A01 from the printing apparatus B1. The control unit B21 of the printing server B2 deletes the information file A01. The communication unit B22 of the printing server B2 transmits a deletion instruction for the information file A01 and the printing job A01 to the printing server A2 (ACT 204).

The communication unit A22 of the printing server A2 receives the deletion instruction for the printing server B2. The control unit A21 of the printing server A2 deletes the information file A01 and the printing job A01 (ACT 105).

This embodiment is summarized below.

According to this embodiment, in a system for specifying a user using a user ID or the like and executing printing, if a plurality of printing servers are provided for, for example, respective different networks, irrespective of in which printing server the user registers a printing job, the user can display and print the registered printing job from any printing apparatus without switching the printing server. Details are as explained below.

When the printing server A2 receives a printing job, if the printing server A2 directly transmits the received printing job to all the other printing servers, a load on networks increases. Therefor, the printing server A2 creates an information file of the received printing job and transmits the information file to all the other printing servers (the printing server B2).

When the printing server B2 receives an information display request from the printing apparatus B1, the printing server B2 transmits information for displaying a printing job list on the basis of the information file to the printing apparatus B1. The printing apparatus B1 receives the information for displaying the printing job list and displays the printing job list.

When the printing apparatus B1 decides printing of a specific printing job from the printing job list, the printing apparatus B1 requests the printing server B2 to transmit the printing job. If the printing server B2 manages (stores) the requested printing job, the printing server B2 transmits the printing job to the printing apparatus B1. If the printing server B2 does not manage (store) the requested printing job, the printing server B2 transmits, on the basis of a registered server address recorded in the information file, to the printing server A2, a transmission instruction for transmitting the printing job to the printing apparatus B1.

When the printing server B2 receives a printing job reception completion notification from the printing apparatus B1, the printing server B2 deletes the information file (if the printing job is present, deletes the printing job as well) and transmits a deletion instruction for the information file to another printing server (the printing server A2).

When the other printing server (the printing server A2) receives the deletion instruction for the information file, the other printing server deletes the information file (if the printing job is present, deletes the printing job as well)

While certain embodiments have been described, these embodiments have been presented by way of example only, and are not intended to limit the scope of the inventions. Indeed, the novel embodiments described herein may be embodied in a variety of other forms; furthermore, various omissions, substitutions, and changes in the form of the embodiments described herein may be made without departing from the spirit of the inventions. The accompanying claims and their equivalents are intended to cover such forms or modifications as would fall within the scope and spirit of the inventions.

What is claimed is:

1. A printing server comprising:
a communication unit configured to communicate with an information processing apparatus that outputs a printing job, another printing server, and a printing apparatus;
a storing unit configured to receive the printing job transmitted from the information processing apparatus and store the printing job;
an information-file generating unit configured to generate, on the basis of the printing job, an information file for managing the printing job stored in the storing unit; and
a control unit configured to transmit the information file generated by the information-file generating unit to the other printing server via the communication unit and, if receiving, via the other printing server, a printing job request from the printing apparatus that communicates with the other printing server, transmit the printing job stored in the storing unit to the printing apparatus.

2. The server according to claim 1, wherein, if determining in response to the printing job request from the printing apparatus and on the basis of the information file that the printing job is stored in the printing server, the other printing server transmits the printing job request to the printing server.

3. The server according to claim 2, wherein the control unit generates the information file including identification information included in the printing job, receives, via the other printing server, the printing job request based on the identification information from the printing apparatus, and transmits the printing job to the printing apparatus.

4. The server according to claim 3, wherein the control unit receives, via the other printing server, the printing job request based on the identification information received by the printing apparatus and transmits the printing job to the printing apparatus.

5. The server according to claim 4, wherein the control unit registers the printing job and generates the information file including registration location information indicating a registration location of the printing job.

6. The server according to claim 5, wherein the control unit receives the printing job request from the other server that determines a request destination of the printing job on the basis of the registration location information included in the information file.

7. A printing system comprising first and second printing servers, wherein
the first printing server communicates with an information processing apparatus that outputs a printing job, the second printing server, and a printing apparatus, receives the printing job transmitted from the information processing apparatus and stores the printing job in a storing unit, generates, in an information-file generating unit, on the basis of the printing job, an information file for managing the printing job stored in the storing unit, transmits the information file to the second printing server and, if receiving, via the second printing server, a printing job request from the printing apparatus that communicates with the second printing server, transmits the printing job stored in the storing unit to the printing apparatus, and
the second printing server receives the information file from the first printing server and, if determining in response to the printing job request from the printing apparatus and on the basis of the information file that the printing job is stored in the first printing server, transmits the printing job request to the first printing server.

8. A printing method comprising:
a first printing server receiving and storing a transmitted printing job, generating an information file for managing the printing job, and transmitting the information file to a second printing server;
the second printing server receiving the information file from the first printing server, determining in response to a printing job request from a printing apparatus and on the basis of the information file whether the printing job is stored in the first printing server and, if determining that the printing job is stored in the first printing server, transmitting the printing job request to the first printing server; and
the first printing server receiving the printing job request from the printing apparatus via the second printing server and transmitting the printing job to the printing apparatus on the basis of the printing job request.

9. The method according to claim 8, further comprising the first printing server generating the information file including identification information included in the printing job, receiving the printing job request based on the identification information from the printing apparatus via the second printing server, and transmitting the printing job to the printing apparatus.

10. The method according to claim 9, further comprising the printing apparatus receiving the identification information, outputting a printing job list based on the information file corresponding to the identification information, transmitting the printing job request corresponding to a printing instruction selected from the printing job list to the second printing server, receiving the printing job from the first printing server, and executing printing on the basis of the printing job.
